(19) United States
(12) Patent Application Publication
(10) Pub. No.: US 2009/0280411 A1
(43) Pub. Date: Nov. 12, 2009

(54) POSITIVE ELECTRODE, PRODUCTION METHOD THEREOF, AND LITHIUM SECONDARY BATTERY USING THE SAME

(76) Inventors: Koji Ohira, Nara (JP); Kasuhito Nishimura, Nara (JP); Naoto Nishimura, Nara (JP)

Correspondence Address: NIXON & VANDERHYE, PC, 901 NORTH GLEBE ROAD, 11TH FLOOR, ARLINGTON, VA, 22203, US

(21) Appl. No.: 12/305,065

(22) PCT Filed: Apr. 10, 2007
(86) PCT No.: PCT/JP2007/057906

§ 371 Date: Dec. 16, 2008

(30) Foreign Application Priority Data
Jun. 16, 2006 (JP) 2006-167951

(51) Int. Cl. H01M 4/48; H01M 4/58; H01M 4/04

(52) U.S. Cl. 429/221; 429/231.95; 429/231.8; 29/623.1

(57) ABSTRACT

A positive electrode for a lithium secondary battery obtained by bonding a positive electrode-active material, a conductive material, and a current collector with a carbon which has a graphitization degree expressed by a peak intensity ratio, i.e. the ratio of peak intensity at 1360 cm⁻¹ to peak intensity at 1580 cm⁻¹ in the argon laser Raman Spectrum, of 1.0 or lower.

### TECHNICAL FIELD

The present invention relates to a positive electrode, the production method thereof, and a lithium secondary battery using the positive electrode. More particularly, the invention relates to a positive electrode for a lithium secondary battery excellent in the cycle characteristics and having a large capacity, its production method, and a lithium secondary battery using the positive electrode. A lithium secondary battery of the invention is preferably usable for a non-aqueous electrolytic secondary battery for electric power storage.

### BACKGROUND ART

Lithium secondary batteries have higher output voltage and higher energy density than those of nickel-cadmium batteries or nickel-hydrogen batteries. Therefore, the lithium secondary batteries tend to become major among secondary batteries. Particularly, as power sources for portable appliances, the lithium secondary batteries have been widely used. Generally, the lithium secondary batteries contain lithium cobaltate (LiCoO₂) as a positive electrode-active material and a carbon material such as graphite as an negative electrode-active material. Further, the lithium secondary battery contains a non-aqueous electrolytic solution obtained by dissolving an electrolyte of a lithium salt such as lithium borofluoride (LiBF₄) or lithium hexafluorophosphate (LiPF₆) in an organic solvent such as ethylene carbonate (EC), diethyl carbonate (DEC), or the like.

In recent years, to heighten the energy density, lithium secondary batteries using, as a positive electrode-active material, lithium nickelate (LiNiO₂), its solid solution Li(Co₁₋ₓNiₓ)O₂), lithium manganate (LiMn₂O₄) having a spinel type structure, or lithium iron phosphate (LiFePO₄) abundant as a resource have been drawing attention.

On other hand, as reported in the report of research granted in 2001, issued by the Lithium Battery Energy Storage Technology Research Association (The Development of New Battery Energy Storage System and The Development of Dispersed-Type Battery Energy Storage Technology) (Non-patent document 1), lithium secondary batteries have drawn attention not only as power sources for portable appliances but also devices for stationary energy storage and devices for energy storage for electric vehicles.

### DISCLOSURE OF THE INVENTION

### Problems to be Solved by the Invention

In the case where lithium secondary batteries are used as devices for energy storage described above, there are following two problems.

The first problem is the life of batteries. The life of lithium secondary batteries presently used for portable appliances is about several hundreds cycles. However it is required for batteries to withstand use for at least several years for energy storage. Therefore, in the case where charging and discharging is carried out once a day, life of several thousands cycles are required for batteries.

For positive electrodes of lithium secondary batteries, binder materials containing resins such as poly(vinylidene fluoride) are generally used. Lithium secondary batteries are charged by the reaction of deintercalation of lithium ion from positive electrode-active materials and intercalation of lithium ion in negative electrode-active materials. Further, discharging is carried out by the reaction of deintercalation of lithium ion from negative electrode-active materials and intercalation of lithium ion in positive electrode-active materials. At the time of charging and discharging, the positive electrode-active materials are expanded or shrunk. Therefore, if cycles are performed, expansion and shrinkage of the positive electrode-active materials themselves are repeated and the positive electrode-active materials are gradually dropped off current collectors and conductive materials. As a result, since inactive parts where charging and discharging cannot be carried out are increased, the capacity of batteries tends to be lowered. Consequently, it becomes difficult to obtain lithium secondary batteries with desired life.

The second problem is the cost. Lithium secondary batteries used generally for portable appliances and having capacity of about 1 Ah have a structure of enclosing the following rolled body or laminated body together with an electrolytic substance in a film made of a metal or a resin film having a metal layer. The rolled body or laminated body has a structure formed by rolling or laminating a positive electrode with a thickness of about a hundred and several tens micron, an negative electrode with a thickness of about a hundred and several tens micron, and a porous insulating separator between them. When lithium secondary batteries with high capacity in the same structure are tried to be obtained, the electrode surface area becomes so wide to complicate the production process. Accordingly, the cost becomes high.

Positive electrode active materials, conductive materials, and positive electrode current collectors of conventional lithium secondary batteries are bonded using a resin such as poly(vinylidene fluoride) (PVdF) as a binder and N-methylpyrrolidone (NMP) as a solvent. A method for prolonging the life of such a positive electrode may be supposedly a method of suppressing the dropping off of the positive electrode-active material by increasing the binder. However, in the method, the ratio of the binder of unit surface area of the positive electrode is increased and the ratio of the positive electrode-active material is decreased. Therefore, this method has a problem that the energy density is decreased and the resistance of the electrodes is increased.

Herein, Japanese Unexamined Patent Publication No. 2005-302300 (Patent Document 1) proposes a method (a method of improving adhesion property and the cycle characteristics) of prolonging the life of a positive electrode by using PVdF with a high weight average molecular weight without increasing the ratio of the binder.

However, to obtain a necessary life as a battery for energy storage, the bonding force of the PVdF is insufficient and a binder with a further firm bonding force is required. Furthers PVdF scarcely provides sufficient conductivity to the positive electrode, and it has a problem that sufficient load characteristics of the positive electrode are hardly obtained. Furthermore, in consideration of the production cost and environmental load at production, PVdF that requires NMP as a solvent is not preferable.

Non-patent Document 1: Report of research granted in 2001 (The Development of New Battery Energy Storage System and The Development of Dispersed-Type Battery Energy Storage Technology, Lithium Battery Energy Storage Technology Research Association)

### Patent Document 1: Japanese Unexamined Patent Publication No. 2005-302300

Means to Solve the Problems

Accordingly, the present invention provides a positive electrode for a lithium secondary battery obtained by bonding a positive electrode-active material, a conductive material, and a current collector with a carbon which has a graphitization degree expressed by a peak intensity ratio, i.e. the ratio of peak intensity at 1360 cm⁻¹ to peak intensity at 1580 cm⁻¹ in an argon laser Raman Spectrum, of 1.0 or lower.

Further, according to the present invention, it is provided that a method of producing the above-mentioned positive electrode comprising thermally treating in an inert atmosphere a current collector on which a mixture of a positive electrode-active material, a conductive material, and a carbon precursor is supported is provided.

Furthermore, according to the present invention, a lithium secondary battery using the above-mentioned positive electrode is provided.

### EFFECTS OF THE INVENTION

According to the present invention, the bonding strength can be improved by bonding a positive electrode-active material, a conductive material and a current collector with carbon, and at the same time, the positive electrode resistance can be lowered. Particularly, since the carbon has 1.0 or lower ratio of peak intensity at 1360 cm⁻¹ to peak intensity at 1580 cm⁻¹ in the argon laser Raman Spectrum, the bonding strength by the carbon can be improved and the conductivity of electrons in the positive electrode can be improved. As a result, it is made possible to produce a positive electrode capable of providing a lithium secondary battery with low capacity decrease in cycles for a long time (e.g., 90% or high for initial capacity of the battery capacity after 500 cycles).

Further, in the case of obtaining the carbon by firing its precursor, since water can be used as a solvent, the positive electrode can be produced at a low cost and low environmental load according to the invention.

### BRIEF DESCRIPTION OF THE DRAWINGS

FIG. 1 is a schematic view illustrating a practical method of a bonding strength test; and

FIG. 2 is a schematic sectional view of a lithium secondary battery of the present invention.

### DESCRIPTION OF THE REFERENCE NUMERALS

1. ultrasonic wave generating portion
2. methanol
3. electrode
4. beaker
6. positive electrode
6a. positive electrode-active material
6b. positive electrode-current collector
7. negative electrode
7a. negative electrode-active material
7b. negative electrode-current collector
8. separator
9. outer package
10. electrolyte

### BEST MODE FOR CARRYING OUT THE INVENTION

### (Positive Electrode)

A positive electrode for a lithium secondary battery of the invention has a configuration formed by bonding a positive electrode-active material, a conductive material and a current collector by carbon. In the positive electrode, the carbon has 1.0 or lower ratio of peak intensity at 1360 cm⁻¹ to peak intensity at 1580 cm⁻¹ in an argon laser Raman Spectrum. Herein, the peak intensity ratio means the graphitization degree and it means that as the value is smaller, the graphitization degree of carbon is promoted more. The peak at 1580 cm⁻¹ is called as G band and derived from the internal vibration in the hexagonal lattice, and the peak at 1360 cm⁻¹ is called as D band and derived from the carbon element such as amorphous carbon or the like having dangling ling bond.

In the case where the peak intensity ratio is higher than 1.0, the graphitization of carbon is not promoted sufficiently and the bonding property becomes insufficient and therefore not preferable. The peak intensity ratio is preferably 0.4 or higher. Carbon having 0.4 or lower peak intensity ratio can be fired at a high temperature. However, if firing is carried out at a high temperature, since the ratio of carbon remaining after firing to the amount of a precursor of the carbon is decreased, it is required to adjust the ratio of the precursor of the carbon to be high. As a result, the energy density of a lithium secondary battery using this positive electrode is sometimes decreased, therefore, it is not preferable. The peak intensity ratio is more preferably in the range of 0.4 to 0.8.

As the positive electrode-active material, lithium-transition metal complex oxides, lithium-transition metal complex sulfides, lithium-transition metal complex nitrides, lithium-transition metal phosphate compounds, and the like may be used. Examples of the lithium-transition metal complex oxides may be lithium cobalt complex oxide (LiₓCoO₂: 0≦x≦2), lithium nickel oxide (Li NiO₂: 0<x <2), lithium nickel cobalt oxide (Liₓ(Ni_{1-y}Co_{y})O₂: 0<x<2, 0<y<1), lithium manganese oxide (LiₓMn₂O₄: 0<x<2), and the like. Examples of the lithium-transition metal phosphate compounds may include lithium iron phosphate (LiₓFePO₄: 0<x<2) and the like. Further, examples of compounds obtained by partially substituting elements of lithium iron phosphate may be compounds defined by a general formula Li₁₋ₐAₐFe₁₋ₘMₘP_{1-z}Z_{z}O₄ in which A is an element of Group IA or IIA; M is at least one kind metal elements; Z is one or more elements selected from Group IIIB, IVB, and VB; and O is oxygen. Further, a, m, and z independently is 0 or higher and less than 1 and is selected to accomplish electric neutralization. Among the compounds, transition metal-lithium phosphate compounds: LiMO₄ (herein, M is one or more elements selected from Fe, Mn, Co, and Ni), which is hard to change in a composition or a structure by heat treatment in a reducing atmosphere, are preferable. The transition metal-lithium phosphate compounds may be provided with electron conductivity by coating with a conductive material. Particularly, olivine type LiFePO₄ is preferable owing to the low cost and low environmental load.

The conductive material is preferably a material having electron conductivity and examples are those that are chemically stable such as carbon black, acetylene black, ketjen black, carbon fibers, conductive metal oxides, and their mixtures. Particularly, VGCF (vapor grown carbon fiber) are preferable since they have high electron conductivity and chemical stability.

Carbon and the conductive material are preferable to be used in the amounts of 1 to 30 parts by weight and 1 to 30 parts by weight, respectively, to 100 parts by weight of the positive electrode-active material.

It is not preferable that the use amount of carbon is less than 1 part by weight, since the bonding force of the positive electrode-active material, conductive material, and current collector becomes so weak to deteriorate the cycle characteristics in some cases. It is not preferable that in case where the carbon is more than 30 parts by weight, the volume occupying in the positive electrode becomes high and the energy density of a battery is lowered.

It is not preferable that the use amount of conductive material is less than 1 part by weight, since the load characteristics as a battery are deteriorated. It is not preferable that in case where the conductive material is more than 30 parts by weight, the intercalation and deintercalation reaction of lithium ion is inhibited and the load characteristics of a battery are deteriorated.

The use amounts of carbon and conductive material are more preferably 1 to 10 parts by weight, and 5 to 20 parts by weight, respectively.

Examples as the current collector may be a foamed (porous) metal having a continuous hole, honeycomb-shape metal, sintered metal, expanded metal, nonwoven fabric, plate, foil, punched plate and foil, and so forth. Particularly, a lath plate is preferable, since it is easily controlled in the thickness and advantageous in terms of the cost. Further, the foamed metal is preferable since the current collector structure is formed three-dimensionally and the dispersion of the positive electrode property is slight. Examples of the current collector that can be used for the positive electrode are stainless steel, aluminum, alloy containing aluminum, and so forth.

The thickness of the positive electrode is preferably 0.2 to 40 mm. It is not preferable that the thickness is thinner than 0.2 mm, since it is required to increase the number of layered sheets of the positive electrode in order to compose a battery with a high capacity. On the other hand, it is not preferable that the thickness is thicker than 40 mm, because the inner resistance of the positive electrode is increased and the load characteristics of a battery are deteriorated.

The evaluation of the bonding strength by quasi-regeneration of the expansion and shrinkage caused along with cycles can be carried out by the following method.

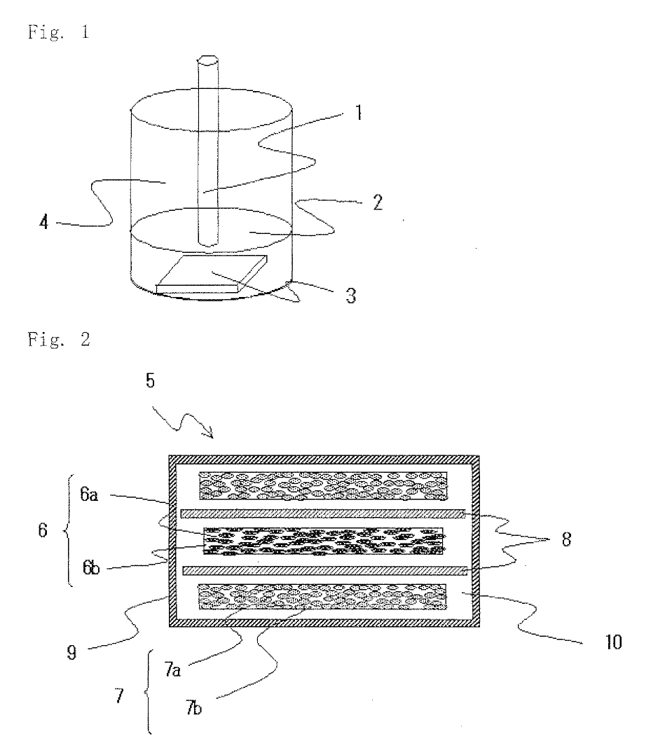

That is, the bonding strength can be evaluated by immersing a positive electrode in methanol, vibrating the positive electrode by irradiating ultrasonic wave at a constant output by a piezoelectric device or the like, and computing the relation between the irradiation energy of the ultrasonic wave and the weight decrease. Specifically, as shown in FIG. 1, 50 cc methanol is poured to a beaker with a diameter of 40 mm and a positive electrode is set in the bottom of the beaker and ultrasonic wave is irradiated at a position of 10 mm from the positive electrode. The positive electrode to which ultrasonic wave is irradiated is preferably those having a weight in the range of 0.5 g to 1 g excluding the weight of the current collector. The frequency of the ultrasonic wave for the irradiation is preferably in the range of 20 kHz to 100 MHz. The irradiation energy is preferably in the range of 1 Wh to 50 Wh and more preferably in the range of 5 Wh to 25 Wh. Herein, the weight reduction ratio is calculated according to (positive electrode weight before ultrasonic wave irradiation-positive electrode weight after ultrasonic wave irradiation)/(positive electrode weight before ultrasonic wave irradiation)×100. The positive electrode weight does not include the weight of the current collector in the case of calculation of the weight reduction ratio.

As the weight reduction ratio measured in the above-mentioned method is smaller, the positive electrode-composing components such as the positive electrode-active material less drop off the current collector: in other words, the bonding strength of the positive electrode-composing components by the carbon is higher.

The positive electrode of the invention can be used as a positive electrode of a lithium secondary battery such as a lithium ion secondary battery, a lithium polymer secondary battery, and the like.

### (Production Method of Positive Electrode)

The positive electrode can be produced, for example, as follows. That is, prescribed amounts of a positive electrode-active material, conductive material and carbon precursor are weighed and mixed to obtain a mixture which is then supported on the current collector. A method of mixing is not particularly limited. A method for supporting may be, for example, a method of supporting the mixture directly on the current collector, a method of adding a solvent to the mixture to obtain a paste mixture and supporting the paste mixture on the current collector.

A method of supporting the paste mixture on the current collector may be a method of applying the paste mixture directly to the current collector or a method of previously forming the paste mixture into an arbitrary shape and transferring it to the current collector.

In the case where the solvent is added to the mixture, it is preferable to carry out drying to remove the solvent after the mixture made to be a paste is supported on the current collector. The drying may be carried out in air or in vacuum. Further, in order to shorten the drying time, it is preferable to carry out drying at a temperature of about 80° C. In the case of using no solvent for the mixture, the drying step is not needed.

The carbon precursor is not particularly limited if it is an organic compound from which carbon derived by heat treatment gives the specified peak intensity ratio. Specifically examples are thermosetting resins such as a phenol resin, polyester resin, epoxy resin, urea resin, melamine resin, and the like; thermoplastic resins such as polyethylene, polypropylene, vinyl chloride resin, poly(vinyl acetate), polyvinylpyrrolidone, acrylic resin, styrol resin, polycarbonates, nylon resins, styrene-butadiene rubber, and polymers and copolymers derived from monomers such as acrylonitrile, methacrylonitrile, vinyl fluoride, chloroprene, vinylpyridine and its derivatives, vinylidene chloride, ethylene, propylene, cellulose, cyclic diene (e.g. cyclopentadiene, 1,3-cyclohexadiene, and the like); carboxymethyl cellulose, carbohydrate such as saccharide (sugar), starch, and paraffin; tar, pitch, coke, and the like.

Since the above-mentioned precursor is carbonized by heat treatment, the component of the precursor is evaporated by thermal decomposition in the heat treatment. Therefore, a precursor from which harmful substances are hardly discharged by the thermal decomposition and which easily gives the specified peak intensity ratio is preferable. Specifically, examples of such a precursor are polyvinylpyrrolidone, carboxymethyl cellulose, poly(vinyl acetate), polyacetylene, compounds consisting of mainly carbon, hydrogen and oxygen such as saccharides and starch, and compounds with high carbon contents such as tar, pitch, coke, and the like.

Further, the precursor is preferably compounds to be carbonized at 800° C. or lower among the abovementioned preferable compounds. Firing at a temperature higher than 800° C. is not preferable since reduction of the positive electrode-active material may possibly be caused. Substantial examples are polyvinylpyrrolidone, carboxymethyl cellulose, polyvinyl acetate), saccharides, and the like.

Particularly, since polyvinylpyrrolidone is easy to be carbonized at a low temperature, and the amount of remaining carbon after the firing is high, polyvinylpyrrolidone is preferable.

The solvent for producing the paste is not particularly limited; however, those in which the precursor is dissolved and/or dispersed are preferable. Examples of the solvent are organic solvents such as N-methylpyrrolidone, acetone, alcohol, and water. Among them, water is preferable since it is economical and has a low load to environments. Additionally, in the case where the precursor is a liquid at room temperature, in the case where the precursor has plasticity by heating, and in the case where the precursor becomes a liquid by heating, it is no need to use the solvent.

Next, the precursor is carbonized by heat treatment of the mixture supported on the current collector in an electric furnace, or the like. The temperature of the heat treatment is preferably a temperature at which the specified peak intensity ratio is obtained and more preferably a temperature at which the positive electrode-active material is not reduced. Specifically, in the case where the positive electrode-active material is LiFePO₄, the heat treatment temperature is preferably 250 to 800° C. The temperature of the heat treatment lower than 250° C. is not preferable since the carbonization of the precursor is not sufficiently promoted. The heat treatment temperature higher than 800° C. is not preferable since the decomposition of LiFePO₄ occurs. The heat treatment temperature is more preferably 500 to 700° C.

In this range, carbon with sufficient electric conductivity can be obtained.

The heating speed in the heat treatment is preferably 600° C./h or lower. The heating speed is more preferably 200° C./h or lower. If the heating speed is adjusted to be slow, carbon with a high graphitization degree can be formed and the bonding strength can be improved. The heating speed is preferably 100° C./h or higher from the viewpoint of shortening a production time.

If oxygen is contained in the atmosphere for the heat treatment, the precursor and the conductive material cannot be carbonized in some cases. Therefore, the atmosphere for the heat treatment is preferably inert atmosphere containing substantially no oxygen. Herein, “containing substantially no oxygen” means the case the oxygen concentration is 0.1% or less by volume. The inert atmosphere means the atmosphere having no reactivity on the components which are to be subjected to the heat treatment and specifically, the atmosphere of nitrogen, argon, neon, or the like may be exemplified. Among them, nitrogen atmosphere is preferable from the viewpoint of economy.

### (Lithium Secondary Battery)

A lithium secondary battery is not particularly limited in other constituent elements as long as it comprises the above-mentioned positive electrode. The lithium secondary battery is generally composed of a positive electrode, an negative electrode, a separator between the positive electrode and the negative electrode, and an electrolyte.

The negative electrode generally has a configuration formed by supporting a mixture containing a negative electrode-active material and arbitrary additives such as a conductive material, a binder, and the like on a current collector.

The negative electrode-active material is preferably a material which can electrochemically intercalat/deintercalate lithium. In order to compose a high energy density battery, a negative electrode-active material having potential for lithium intercalation/deintercalation near the precipitation/dissolution potential of metal lithium is preferable. Typical examples are carbon materials such as granular (scaly, bulky, fibrous, whisker-like, spherical, crushed granular, and the like) natural or artificial graphite. Examples of artificial graphite may include graphite obtained by graphitizing mesocarbon micro beads, meso-phase pitch powder, isotropic pitch powder, or the like. Further, graphite particles adhering amorphous carbon on the surface may also be used. Among them, natural graphite is preferable, since it is economical and is suitable to provide a high energy density battery having a redox potential near to the redox potential of lithium.

Lithium-transition metal oxides, lithium-transition metal nitrides, transition metal oxides, silicon oxide and the like are also usable as the negative electrode active material. Among them, Li₄Ti₅O₁₂ is preferable since flatness of the potential is high and volume fluctuation due to charging and discharging is slight.

Additives such as the conductive material, the binder, and the like are not particularly limited, and those known conventionally in this field are all usable.

Examples as the current collector may be a foamed (porous) metal having continuous holes, honeycomb-shape metal, sintered metal, expanded metal, nonwoven fabric, plate, foil, punched plate and foil, and so forth. Particularly, a lath plate is preferable, since it is controllable in the thickness and advantageous in terms of the cost. Further, foamed metals are preferable since the current collector structure is formed three-dimensionally and therefore the dispersion of the electrode property is slight. Examples of the current collector be used for the negative electrode are nickel, copper, stainless steels, and so forth.

The thickness of the negative electrode is preferably 0.2 to 20 mm. It is not preferable that the thickness is thinner than 0.2 mm, since it is required to increase the number of layered sheets of the negative electrode in order to compose a battery with a high capacity. On the other hand, it is not preferable that the thickness is thicker than 20 mm, since the inner resistance of the negative electrode is increased and the load characteristics of a battery are deteriorated.

The negative electrode is not particularly limited and produced by a conventional method.

Next, a battery is assembled using the above-mentioned positive electrode and negative electrode (hereinafter, collectively referred to as electrodes). The process is as follows.

The positive electrode and the negative electrode are layered while sandwiching a separator between them. The layered electrodes may have reed-like flat shape. Further, in the case of producing a cylindrical or flat battery, the layered electrodes may be rolled up.

Examples to be used as the separator may be a porous material, a nonwoven fabric, or the like. The material of the separator is preferably those which are not dissolved or swollen in an organic solvent contained in an electrolyte described below. Specifically, a polyester type polymer, polyolefin type polymer (e.g. polyethylene, polypropylene), ether type polymer, inorganic material such as glass, and the like can be exemplified.

One or a plurality of the layered electrodes are inserted in the inside of a battery container. Generally, the positive electrode and the negative electrode are connected to outer conductive terminals of the battery. Thereafter, the battery container is sealed to shut the electrodes and the separator from ambient air. A method for sealing is, in the case of a cylindrical battery, generally a method of fitting a cover having a packing made of a resin in an aperture part of the battery's container and caulking the container. Further, in the case of a square battery, a method of attaching a cover so-called a sealing plate made of a metal to an aperture part and welding the cover may be employed. In addition to these methods, a method of sealing with a binder and a method of fixing with bolts via a gasket may also be employed. Further, a method of sealing with a laminate film obtained by sticking a thermoplastic resin to a metal foil is also employed. An aperture part for an electrolyte injection may be formed at the time of sealing.

Next, the electrolyte is injected to the layered electrodes. As the electrolyte, for example, an organic electrolyte, gel-like electrolyte, polymer solid electrolyte, inorganic solid electrolyte, molten salts, and the like may be used. After the electrolyte is injected, the aperture part of the battery is scaled. Electricity may be applied to the electrodes before sealing to remove the generated gas. Examples of the organic solvent are a cyclic carbonate such as propylene carbonate (PC), ethylene carbonate (EC), and butylene carbonate; linear carbonate such as dimethyl carbonate (DMC), diethyl carbonate (DEC), ethyl methyl carbonate, and dipropyl carbonate; lactones such as γ-butyrolactone (GBL) and γ-valerolactone; furan such as tetrahydrofuran and 2 methyltetrahydrofuran; ether such as diethyl ether, 1,2-dimethoxyethane, 1,2-diethoxyethane, ethoxymethoxyethane, and dioxane; dimethyl sulfoxide, sulfolane, methylsulfolane, acetonitrile, methyl formate, methyl acetate, and the like. These organic solvents may be used alone or two or more of them may be used in mixture. Particularly, GBL has properties of a high dielectric constant and low viscosity and is excellent in the oxidation resistance and advantageous in the high boiling point, low vapor pressure, and high flame point. Therefore, GBL is more preferable as a solvent for an electrolytic solution for a large scale lithium secondary battery which is required to be very much safer than a conventional small type lithium secondary battery. Further, cyclic carbonates such as PC, EC, and butylene carbonate have a high boiling point and are therefore preferable to be mixed with GBL.

Examples of the electrolytic salt may be lithium salts such as lithium borofluoride (LiBF₄), lithium hexafluorophosphate (LiPF₆), lithium trifluoromethanesulfonate (LiCF₃SO₃), lithium trifluoroacetate (LiCF₃COO), lithium bis(trifluoromethanesulfone) imide (LiN(CF₃SO₂)₂), and the like. These electrolytic salts may be used alone or two or more of them may be used in mixture.

The salt concentration of the electrolytic solution is preferably 0.5 to 3 mol/L.

The lithium secondary battery can be obtained in the above-mentioned manner.

### EXAMPLES

Hereinafter, the present invention will be more specifically described by Examples.

### Example 1

Electrodes were produced according to the following procedure.

### Production of Positive Electrode

LiFePO₄ was used as a positive electrode-active material: VGCF was used as a conductive material: and polyvinylpyrrolidone was used as a precursor of a binder. They were mixed at a weight ratio of 100:18:72. The mixture was mixed with 100 ml of water and kneaded by a kneading apparatus to produce a paste. The produced paste was applied in a thickness of 2 mm to both faces of an expanded metal (manufactured by Nippon Metalworking, Japan Inc.) of a stainless steel with thickness 100 μm, width 15 cm×length 20 cm to form coating layers. Specifically, the paste was applied to one face of the expanded metal and dried and thereafter, the paste was applied to the rear face and dried to form the coating layers. In addition, an electric current terminal made of aluminum with 5 mm width and 100 μm thickness was previously welded to the expanded metal of the stainless steel. The expanded metal coated with the paste was left in a drier at 60° C. for 12 hours to remove water as a solvent.

Thereafter, the expanded metal of the stainless steel provided with the coating layers was heated at 600° C. in nitrogen atmosphere. Specifically, the temperature in a furnace was increased to 600° C. from room temperature (about 25° C.) for 3 hours and after it was increased to 600° C. and the expanded metal was kept for 3 hours, left until the temperature became room temperature. A positive electrode was obtained in this heat treatment.

### Evaluation of Positive Electrode

### (Measurement Method of Peak Intensity Ratio of Positive Electrode)

Parts of the coating layers were scraped at five points from each positive electrode produced by the method same as the above-mentioned production method and the scraped coating layers were subjected to Raman spectroscopy (Analysis apparatus: RAMAN-500-2 manufactured by SPEX Company, Analysis condition: oscillation wavelength 5.145 A, output 20 mW, integrating time 10 seconds). The graphitization degree of carbon was calculated from the peak intensity ratio at 1360 cm⁻¹ to 1580 cm⁻¹ in the argon-laser Raman spectrum.

### (Measurement of Bonding Strength)

A positive electrode with thickness 100 μm, width 3 cm×length 3 cm was produced by the method same as the above-mentioned production method and subjected to a bonding strength test by ultrasonic wave irradiation. Specifically, as shown in FIG. 1, 50 cc of methanol was poured to a beaker with 40 mm diameter and the positive electrode was put in the bottom of the beaker and ultrasonic wave of 150 W output was irradiated at a position of 10 mm from the positive electrode (Ultrasonic wave irradiation apparatus. VCX-750 manufactured by SONICS & MATERIALS INC., irradiation condition: output 150 W, frequency 20 kHz). Thereafter, the positive electrode was dried at 60° C. in vacuum to measure the weight. The weight decrease ratio was calculated by comparing the initial weight of the positive electrode with the weight of the positive electrode after ultrasonic wave irradiation. The bonding strength was evaluated in accordance with the calculated weight decrease ratio.

The peak intensity ratio, the initial battery weight, and the weight decrease ratio are shown in Table 1.

### Production of Negative Electrode

Natural graphite was used for the negative electrode-active material: VGCF was used as the conductive material: and poly(vinylidene fluoride) was used as a binder. They were mixed at a ratio of 100:25:10 by weight. The mixture was mixed with 150 ml of NMP and kneaded by a kneading apparatus to produce a paste. The produced paste was packed in a foamed nickel with a thickness of 1 mm and width 15 cm×length 20 cm. Additionally, an electric current terminal made of nickel with 5 mm width and 100 μm thickness was previously welded to the foamed nickel. The foamed nickel coated with the paste was left in a drier at 150° C. for 8 hours to remove NMR that is a solvent, and accordingly an negative electrode was obtained.

### Production of Lithium Secondary Battery

A battery was produced using the above-mentioned positive electrode and negative electrode according to the following procedure and subjected to the cycle characteristics evaluation.

At first, the positive electrode and negative electrode were dried at 150° C. in reduced pressure for 12 hours to remove water. In addition, the work thereafter was entirely carried out in a dry box at −80° C. or less in an argon atmosphere.

Next, the positive electrode and negative electrode were laminated while inserting a separator having a thickness of 50 μm and made of a porous polyethylene between them. The obtained laminated body was inserted in a bag made of a laminate film obtained by welding a 50 μm-thick low melting point polyethylene film to a 50 μm-thick aluminum foil. An electrolytic solution was injected in the bag and the aperture part was sealed by thermal bonding to complete a lithium secondary battery. The electrolytic solution used here was an electrolytic solution obtained by dissolving LiPF₆ in a concentration of 1.4 mol/L in a mixed solvent of γ-butyrolactone and ethylene carbonate at a ratio of 7:3 by volume.

### (Measurement of Rated Capacity)

Each completed battery was charged at a constant electric current of 0.4 A until the voltage of the battery became 3.8 V and thereafter, after 16 hours at 3.8 V or when the charging electric current became 0.04 A, the charging was finished. Thereafter, discharging was carried out at 0.4 A until the voltage of the battery became 2.25 V. The discharge capacity at that time was defined as the rated capacity of the battery.

### (Evaluation of Cycle Characteristics)

The cycle evaluation was carried out by an accelerated test. Specifically, after charging at a constant electric current of 4 A to increase the voltage of each battery to 3.8 V, the charging at the constant voltage of 3.8 V to electric current lowered to 0.4 A and discharging at 4 A to 2.25 V were repeated 499 times. Thereafter, the charging and discharging were repeated in the same condition as that for the measurement of the rated capacity and the discharging capacity measured at that time was defined as the capacity after 500 cycles. The retention ratio of the capacity at the time of the 500th cycle was calculated from the capacity after 500 cycles and the discharge capacity at the initial cycle to evaluate the cycle characteristics. This test was an accelerated test about 10 times as fast as that in a general condition (charging and discharging for 10 hour rate).

The rated capacity, capacity at the 500th cycle, and the retention ratio at the 500th cycle are shown in Table 1.

### Example 2

A positive electrode is produced in the same procedure as that of Example 1, except that the heat treatment was carried out by heating to 600° C. in 6 hours in a place of the heat treatment by heating to 600° C. in 3 hours and a battery was produced using the obtained positive electrode in the same procedure as that of Example 1. The evaluation results of the positive electrode and the battery are shown in Table 1.

### Example 3

A positive electrode is produced in the same procedure as that of Example 1, except that the heat treatment was carried out by heating to 600° C. in 1 hour in place of the heat treatment by heating to 600° C. in 3 hours and a battery was produced using the obtained positive electrode in the same procedure as that of Example 1. The evaluation results of the positive electrode and the battery are shown in Table 1.

### Example 4

A positive electrode is produced in the same procedure as that of Example 1, except that the heat treatment was carried out by heating to 500° C. in 3 hours and keeping at 500° C. for 3 hours in place of the heat treatment by heating to 600° C. in 3 hours and keeping at 600° C. for 3 hours, and a battery was produced using the obtained positive electrode in the same procedure as that of Example 1. The evaluation results of the positive electrode and the battery are shown in Table 1.

### Comparative Example 1

A positive electrode is produced in the same procedure as that of Example 1, except that the heat treatment was carried out by heating to 400° C. in 3 hours and keeping at 400° C. for 3 hours in place of the heat treatment by heating to 600° C. in 3 hours and keeping at 600° C. for 3 hours, and a battery was produced using the obtained positive electrode in the same procedure as that of Example 1. The evaluation results of the positive electrode and the battery are shown in Table 1.

### Comparative Example 2

A positive electrode is produced in the same procedure as that of Example 1, except that no heat treatment was carried out in place of the heat treatment by heating to 600° C. in 3 hours and keeping at 600° C. for 3 hours and a battery was produced using the obtained positive electrode in the same procedure as that of Example 1. The evaluation results of the positive electrode and the battery are shown in Table 1.

### Comparative Example 3

LiFePO₄ was used as a positive electrode-active material: VGCF was used as a conductive material: and polyvinylpyrrolidone was used as a precursor of a binder. They were mixed at a weight ratio of 100:18:10. The mixture was mixed with 100 ml of N-methylpyrrolidone and kneaded by a kneading apparatus to produce a paste. The produced paste was applied in a thickness of 2 mm to both faces of an expanded metal of a stainless steel with thickness 100 μm, width 15 cm×length 20 cm to form coating layers. An electric current terminal made of aluminum with 5 mm width and 100 μm thickness was previously welded to the expanded metal of the stainless steel. The stainless expanded metal coated with the paste was left in a drier at 60° C. for 12 hours to remove water as a solvent.

A battery was produced in the same manner as that of Example 1, except that the positive electrode produced in the above-mentioned procedure was used and the cycle characteristics were evaluated.

TABLE 1

| | | Initial positive | | | | |
|---|---|---|---|---|---|---|
| | | electrode weight | | | | Retention |
| | Peak | (excluding weight | Weight | | Capacity at | ratio of the |
| | intensity | of current | decrease | Rated | the 500th | 500th cycle |
| | ratio | collector) (g) | ratio (%) | capacity (Ah) | cycle (Ah) | (%) |
| Example 1 | 0.537 | 0.6455 | 0.68 | 4.05 | 3.75 | 92.7 |
| Example 2 | 0.488 | 0.7560 | 0.59 | 3.97 | 3.78 | 95.3 |
| Example 3 | 0.631 | 0.7987 | 1.10 | 3.94 | 3.58 | 91.0 |
| Example 4 | 0.794 | 0.7853 | 2.67 | 3.88 | 3.50 | 90.3 |
| Comparative | 1.125 | 0.7532 | 6.88 | 3.92 | 2.04 | 52.2 |
| Example 1 | | | | | | |
| Comparative | — | 0.7472 | — | — | — | — |
| Example 2 | | | | | | |
| Comparative | — | 0.7138 | 5.10 | 3.22 | 2.39 | 74.3 |
| Example 3 | | | | | | |

From the results of Examples 1 to 4 and Comparative Examples 1 to 3, it can be understood that if the peak intensity ratio is 1.0 or less, the weight decrease ratio after the ultrasonic wave irradiation can be kept to be 5% or less. It can be understood that the cycle characteristics of a battery can be improved by keeping the weight decrease ratio 5% or less.

In the case where no firing was carried out for the positive electrode (Comparative Example 2), the bonding strength was low and the positive electrode could not be used as an electrode.

In the case where poly(vinylidene fluoride) (PVdF) was used as a binder (Comparative Example 3), it can be understood that not only the weight decrease ratio become 5% or higher but also the resistance of the positive electrode is increased and therefore, the rated capacity becomes low.

Further, it is made clear that the weight decrease ratio is decreased most by heat treatment condition for the positive electrode is adjusted to be heating to 600° C. in 6 hours and keeping at 600° C. for 3 hours such as Example 2. As a result, the cycle characteristics are also understood to be the highest.

The invention thus described, it will be obvious that the same may be varied in many ways. Such variations are not to be regarded as a departure from the sprits and scope of the invention, and all such modifications as would be obvious to one skilled in the art are intended to be included within the scope of the following claims.

This application is related to Japanese application No. 2006-167951 filed on Jun. 16, 2006, the disclosure of which is incorporated by reference in its entirety.

What is claimed is:

1. A positive electrode for a lithium secondary battery obtained by bonding a positive electrode-active material, a conductive material, and a current collector with a carbon which has a graphitization degree expressed by a peak intensity ratio, i.e. the ratio of peak intensity at 1360 cm⁻¹ to peak intensity at 1580 cm⁻¹ in the argon laser Raman Spectrum, of 1.0 or lower.

2. The positive electrode for the lithium secondary battery according to claim 1, wherein the peak intensity ratio ranges from 0.4 to 1.0.

3. The positive electrode for the lithium secondary battery according to claim 1, wherein the carbon is a carbon formed by heat treating a carbon precursor under an inert atmosphere.

4. The positive electrode for the lithium secondary battery according to claim 3, wherein the carbon precursor is polyvinylpyrrolidone, carboxymethyl cellulose, poly(vinyl acetate) or saccharides.

5. The positive electrode for the lithium secondary battery according to claim 1, wherein the carbon is used in the range of 1 to 30 parts by weight to 100 parts by weight of the positive electrode-active material.

6. The positive electrode for the lithium secondary battery according to claim 1, wherein the conductive material is a vapor grown carbon fiber, and the positive electrode-active material is LiFePO₄.

7. A method of producing a positive electrode according to claim 1 comprising thermally treating, in an inert atmosphere, a current collector on which a mixture of a positive electrode-active material a conductive material, and a carbon precursor is supported.

8. The method of producing the positive electrode according to claim 7, wherein the mixture contains water as a solvent.

9. The method of producing the positive electrode according to claim 7, wherein the thermal treatment is carried out in the temperature from 250° C. to 800° C.

10. The method of producing the positive electrode according to claim 7, wherein a heating speed until the temperature at the thermal treatment from a temperature before the thermal treatment is 200° C./h or lower.

11. A lithium secondary battery using the positive electrode according to claim 1.
